(19) United States
(12) Patent Application Publication
(10) Pub. No.: US 2012/0033819 A1
(43) Pub. Date: Feb. 9, 2012

(54) SIGNAL PROCESSING METHOD, ENCODING APPARATUS THEREFOR, DECODING APPARATUS THEREFOR, AND INFORMATION STORAGE MEDIUM

(75) Inventors: Nam-suk LEE, Suwon-si (KR); Jong-Hoon JEONG, Suwon-si (KR)

(73) Assignee: SAMSUNG ELECTRONICS CO., LTD., Suwon-si (KR)

(21) Appl. No.: 13/204,200

(22) Filed: Aug. 5, 2011

Related U.S. Application Data
(60) Provisional application No. 61/371,294, filed on Aug. 6, 2010.

(30) Foreign Application Priority Data
Jun. 10, 2011 (KR) 10-2011-0056342

(51) Int. Cl. H04R 5/00

(52) U.S. Cl. 381/22; 381/23

(57) ABSTRACT

Provided are a signal processing method capable of inserting additional information into a bitstream without departing from the AC-3 standard or the Enhanced AC-3 standard. The signal processing method includes: extracting additional information which is for performing at least one of a channel number expansion of an audio signal in an encoding apparatus and a three-dimensional (3D) reproduction of the audio signal in the encoding apparatus; encoding the audio signal according to a predetermined standard; formatting the encoded audio signal into a bitstream including bitstream information, at least one audio block and an auxiliary data field; and inserting the additional information into at least one of additional bitstream information included in the bitstream information, a skip field included in the audio block and auxiliary data bits included in the auxiliary data field.

### CROSS-REFERENCE TO RELATED PATENT APPLICATION

This application claims priority from U.S. Provisional Application No. 61/371,294 filed on Aug. 6, 2010, and Korean Patent Application No. 10-2011-0056342, filed on Jun. 10, 2011 in the Korean Intellectual Property Office, the disclosures of which are incorporated herein in their entirety by reference.

### BACKGROUND

1. Field

Method and apparatuses consistent with exemplary embodiments relate to a signal processing method, an encoding apparatus therefor, a decoding apparatus therefor, and an information storage medium, and more particularly, to a signal processing method for inserting additional information into a bitstream, an encoding apparatus therefor, a decoding apparatus therefor, and an information storage medium.

2. Description of the Related Art

To compress and transmit an audio signal, and receive the compressed audio signal and restore the original audio signal, a decoder is used in a transmission end, and an encoder is used in a reception end. The transmission end and the reception end respectively compress and restore an audio signal according to a predetermined standard.

One standard for transmitting an audio signal is Audio Coding-3 (AC-3). AC-3 is a third format of an audio coding scheme developed by Dolby Laboratories, Inc. in the United States of America and an audio standard for Digital Video Discs (DVDs). AC-3 uses 5.1 channels to represent sound. In particular, AC-3 uses 5.1 channels for separately outputting audio signals through 6 corresponding speakers, i.e., a left speaker, a right speaker, a center speaker, a left surround speaker, a right surround speaker, and a sub-woofer speaker for a low frequency effect.

Recently, to implement a more stereoscopic sound system, methods and apparatuses for generating an audio signal by increasing the number of audio channels more than the 5.1 channels have been developed. For example, a 10.2-channel audio system capable of outputting separate audio signals to 12 corresponding speakers has been developed.

The AC-3 standard limits the number of compressible audio channels to 5+1=6. Thus, according to the AC-3 standard, only bitstreams conforming to 5.1 channels can be generated and transmitted, but bitstreams beyond 5.1 channels cannot be generated or transmitted.

The Enhanced AC-3 standard obtained by enhancing the AC-3 standard limits the number of compressible audio channels to maximum 13.1 channels. Thus, bitstreams beyond 13.1 channels cannot be generated or transmitted under the Enhanced AC-3 standard.

Accordingly, a method and apparatus for generating and transmitting an audio signal beyond 5.1 channels under the AC-3 standard are required.

In addition, a method and apparatus for generating and transmitting an audio signal beyond 13.1 channels under the Enhanced AC-3 standard are required.

### SUMMARY OF THE INVENTION

One or more exemplary embodiments may overcome the above disadvantages and other disadvantages not described above. However, it is understood that one or more exemplary embodiment are not required to overcome the disadvantages described above, and may not overcome any of the problems described above.

According to an aspect of an exemplary embodiment, there is provided a signal processing, the method including: extracting additional information which is for performing at least one of a channel number expansion of an audio signal in an encoding apparatus and a three-dimensional (3D) reproduction of the audio signal in the encoding apparatus; encoding the audio signal according to a predetermined standard; formatting the encoded audio signal into a bitstream including bitstream information, at least one audio block and an auxiliary data field; and inserting the additional information into at least one of additional bitstream information included in the bitstream information, a skip field included in the audio block and auxiliary data bits included in the auxiliary data field.

The additional information may include at least one of multi-channel restoration information for expanding a number of channels to be greater than a number of audio channels included in the bitstream, and 3D information of the audio signal.

The multi-channel restoration information may include at least one of information regarding the audio channels, information for down-mixing the audio signal according to a number of channels defined in the predetermined standard and parameter information for up-mixing the down-mixed audio signal.

The bitstream information may include: additional bitstream existence information indicating whether the additional bitstream information exists; and length information of the additional bitstream information, wherein the additional bitstream information includes the additional information.

The audio block may include: skip field existence information indicating whether the skip field exists; and length information of the skip field, wherein the skip field includes the additional information.

The auxiliary data field may include: the auxiliary data bits including the additional information; length information of the auxiliary data; and auxiliary data existence information which indicates whether the auxiliary data exists.

The signal processing method may further include determining whether to perform at least one of the channel number expansion and the 3D reproduction of the audio signal.

If a number of channels included in the audio signal input to the encoding apparatus is greater than a number of channels allowed in the predetermined standard, the encoding may include down-mixing the audio signal according to a number of channels allowed in the predetermined standard.

If the additional information is inserted into the bitstream, the method further include transmitting the bitstream from the encoding apparatus to the decoding apparatus.

The signal processing method may further include: deformatting the bitstream in the decoding apparatus; and extracting the additional information from at least one of the additional bitstream information, the skip field and the auxiliary data bits of the deformatted bitstream.

The signal processing method may further include: determining whether an expanded channel exists, based on the extracted additional information; and if an expanded channel exists, decoding the deformatted bitstream according to the expanded number of channels, wherein the decoding the deformatted bitstream is based on the extracted additional information.

The signal processing method may further include: determining whether the decoding apparatus can perform the channel number expansion.

If the decoding apparatus cannot perform the channel number expansion, the method may further include decoding the deformatted bitstream without extracting the additional information.

According to an aspect of another exemplary embodiment, there is provided an encoding apparatus including: a controller which extracts additional information that is information for performing at least one of a channel number expansion of an audio signal and a three-dimensional (3D) reproduction of the audio signal; an encoder which encodes the audio signal according to a predetermined standard under a control of the controller; and a formatter which formats the encoded audio signal into a bitstream including bitstream information, at least one audio block and an auxiliary data field, wherein the controller which controls to insert the additional information into at least one of additional bitstream information included in the bitstream information, a skip field included in the audio block and auxiliary data bits included in the auxiliary data field.

The additional information may include at least one of multi-channel restoration information, which is for expanding the number of channels to be greater than a number of audio channels included in the bitstream, and 3D information of the audio signal.

If the additional information is inserted into the bitstream, the controller may transmit the bitstream from the encoding apparatus to a decoding apparatus.

According to an aspect of another exemplary embodiment, there is provided a decoding apparatus including: a deformatter which deformats a bitstream including bitstream information, at least one audio block and an auxiliary data field; a controller which extracts additional information, which is for performing at least one of a channel number expansion and a three-dimensional (3D) reproduction of the bitstream from at least one of additional bitstream information included in the bitstream information, a skip field included in the audio block and auxiliary data bits included in the auxiliary data field; and a decoder which decodes the deformatted bitstream.

Based on the extracted additional information, the controller may determine whether an expanded channel exists, and if an expanded channel exists, the decoder decodes the deformatted bitstream according to meet the expanded number of channels.

The additional information may include at least one of multi-channel restoration information, which is for expanding the number of channels to a number greater than a number of audio channels included in the bitstream, and 3D information of the audio signal.

According to an aspect of another exemplary embodiment, there is provided a non-transitory information storage medium storing a bitstream having an audio signal, wherein the bitstream includes: bitstream information including an additional bitstream information area; at least one audio block including a skip field area; and an auxiliary data field including an auxiliary data bit area wherein at least one of the additional bitstream information area, the skip field area and the auxiliary data bit area includes additional information which is for performing at least one of a channel number expansion and a three-dimensional (3D) reproduction of the audio signal.

The additional information may include at least one of multi-channel restoration information, which is for expanding the number of channels to a number greater than a number of audio channels included in the bitstream, and 3D information of the audio signal.

The multi-channel restoration information may include at least one of information regarding the audio channels, information for down-mixing the audio signal according to a number of channels defined in the predetermined standard, and parameter information for up-mixing the down-mixed audio signal.

The bitstream information may include: additional bitstream existence information which indicates whether the additional bitstream information exists; and length information of the additional bitstream information, wherein the additional bitstream information includes the additional information.

The audio block may include: skip field existence information which indicates whether the skip field exists; and length information of the skip field, wherein the skip field includes the additional information.

The auxiliary data field may include: the auxiliary data bits which include the additional information; length information of the auxiliary data; and auxiliary data existence information which indicates whether the auxiliary data exists.

### BRIEF DESCRIPTION OF THE DRAWINGS

The above and other features will become more apparent by describing in detail exemplary embodiments thereof with reference to the attached drawings in which:

FIG. 1 is a block diagram of an audio system for transmitting and receiving an audio signal;

FIG. 2 is a block diagram of an encoding apparatus according to an exemplary embodiment and a block diagram of a decoding apparatus according to an exemplary embodiment;

FIG. 3 is a flowchart illustrating a signal processing method according to an exemplary embodiment;

FIG. 4 is a configuration diagram of a bitstream according to an exemplary embodiment;

FIG. 5 is a configuration diagram of a bitstream according to the AC-3 standard and a configuration diagram of a bitstream according to the Enhanced AC-3 standard;

FIG. 6 is a configuration diagram of a bitstream into which additional information is inserted, according to an exemplary embodiment;

FIG. 7 illustrates bitstream information including additional information;

FIG. 8 illustrates an audio block including additional information;

FIG. 9 illustrates an auxiliary data field including additional information;

FIG. 10 is a flowchart illustrating a signal processing method according to another exemplary embodiment;

FIG. 11 is a flowchart illustrating a signal processing method according to another exemplary embodiment; and

FIG. 12 is a flowchart illustrating a signal processing method according to another exemplary embodiment.

### DETAILED DESCRIPTION

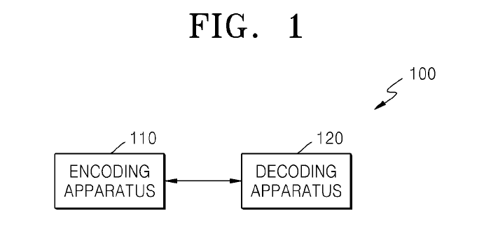

FIG. 1 is a block diagram of an audio system 100 for transmitting and receiving an audio signal.

Referring to FIG. 1, the audio system 100 includes an encoding apparatus 110 that is a transmission end of an audio signal and a decoding apparatus 120 that is a reception end of the audio signal.

The encoding apparatus 110 receives an audio signal including a plurality of channels and compresses the audio signal according to a predetermined standard, e.g., the AC-3 or Enhanced AC-3 standard. Hereinafter, the audio system 100 operating according to the AC-3 standard is illustrated. That is, the encoding apparatus 110 performs AC-3 encoding and transmits an encoded bitstream to the decoding apparatus 120.

The decoding apparatus 120 receives the encoded bitstream and decodes the encoded bitstream to output the original audio signal. That is, the decoding apparatus 120 generates a restored audio signal by performing AC-3 decoding.

In general, the encoding apparatus 110 outputs a bitstream having the number of channels limited to 5.1 channels according to the AC-3 standard. Also, the decoding apparatus 120 typically outputs an audio signal having 5.1 channels by restoring the bitstream. That is, the decoding apparatus 120 can only generate audio signals having 5.1 channels but cannot generate an audio signal having an expanded number of channels more than the 5.1 channels.

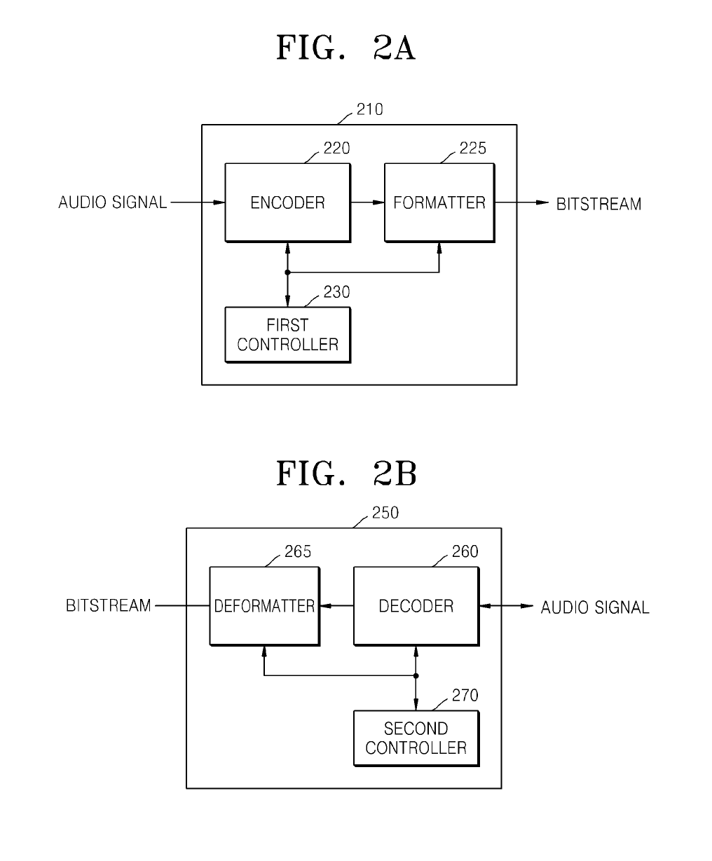

Hereinafter, a signal processing method capable of performing at least one of channel number expansion and 3D reproduction of an audio signal by inserting additional information into a bitstream according to an exemplary embodiment, an encoding apparatus therefor, a decoding apparatus therefor, and an information storage medium will be described in detail with reference to FIGS. 2 to 12.

FIG. 2 is a block diagram of an encoding apparatus 210 according to an exemplary embodiment and a block diagram of a decoding apparatus 250 according to an exemplary embodiment. The encoding apparatus 210 and the decoding apparatus 250 may perform encoding and decoding according to at least one of the AC-3 standard and the Enhanced AC-3 standard, respectively.

Hereinafter, it is illustrated that the encoding apparatus 210 and the decoding apparatus 250 perform encoding and decoding according to the AC-3 standard, respectively.

FIG. 2A is a block diagram of the encoding apparatus 210 according to an exemplary embodiment.

Referring to FIG. 2A, the encoding apparatus 210 includes an encoder 220, a formatter 225, and a controller 230.

Hereinafter, the controller 230 included in the encoding apparatus 210 is called a first controller 230, and a controller 270 included in the decoding apparatus 250 is called a second controller 270.

The encoder 220 receives an audio signal and encodes the received audio signal under a control of the first controller 230.

In detail, the received audio signal may be an audio signal of 10.2 channels. The encoder 220 may compress the received audio signal to an audio signal of maximum 5.1 channels according to the AC-3 standard. Thus, the encoder 220 generates and outputs an audio signal of 5.1 channels by down-mixing the audio signal of 10.2 channels.

The formatter 225 formats the encoded audio signal to a bitstream including bitstream information (BSI), at least one audio block (AB), and an auxiliary data field (Aux) under a control of the first controller 230.

The first controller 230 controls to insert additional information into at least one of additional BSI (addbsi) included in the BSI, a skip field (skipfld) included in the AB, and auxiliary data bits (auxbits) included in the auxiliary data field.

The additional information includes at least one of multi-channel restoration information for expanding the number of channels to a number greater than the number of audio channels included in the bitstream and 3D information of the audio signal.

For example, when the bitstream output from the encoding apparatus 210 includes 5.1 channels, i.e., 6 channels, the multi-channel restoration information may be a parameter value required for the decoding apparatus 250 to perform decoding in order to receive the bitstream including 5.1 channels and output an audio signal including 10.2 channels.

In detail, the multi-channel restoration information may include at least one of information regarding the audio channels, a method of down-mixing the audio signal to meet the number of channels defined in the predetermined standard, and parameter information used to up-mix the down-mixed audio signal.

In detail, the information regarding the audio channels includes the number of layers, the number of speakers per layer, and a speaker configuration per layer. For example, in a case of 5.1 channels, there are front and rear layers, wherein the front layer includes 3 speakers on the left, right and center, and the rear layer includes 2 speakers on the left and right. The left, right and center speakers of the front layer may be disposed in a predetermined configuration.

The down-mixing method includes a formatting method or formatting information for down-mixing an audio signal including the number of channels more than the number of channels allowed in the predetermined standard to meet the allowed number of channels. In detail, the down-mixing method includes a formatting method or formatting information for down-mixing channels more than the number of channels allowed in an AC-3 audio coding mode (acmod).

The parameter information may include spatial parameter information applied when the decoding apparatus 250 performs up-mixing. In detail, the spatial parameter information may include at least one of a parameter indicating a signal level relationship between an input signal and an output signal, a parameter indicating a phase relationship between the input signal and the output signal, and correlation information between the input signal and the output signal. For example, the input signal corresponds to signal before encoding and the output signal corresponds to signal after encoding.

The 3D information of the audio signal may include at least one of depth information and layer information of the audio signal.

The first controller 230 may transmit the bitstream into which the additional information is inserted to the decoding apparatus 250.

FIG. 2B is a block diagram of the decoding apparatus 250 according to an exemplary embodiment.

Referring to FIG. 2B, the decoding apparatus 250 includes a decoder 260, a deformatter 265, and the second controller 270.

The deformatter 265 receives the bitstream including the BSI, the AB, and the auxiliary data field and deformats the received bitstream. In detail, the deformatter 265 deformats the format of the received bitstream so that the received bitstream has the format before passing through the formatter 225.

The second controller 270 extracts the additional information from at least one of the additional BSI included in the BSI, the skip field included in the AB, and auxiliary data bits included in the auxiliary data field.

The decoder 260 decodes the deformatted bitstream according to the predetermined standard.

In detail, the second controller 270 may determine whether an expanded channel exists, based on the extracted additional information. If an expanded channel exists as a result of the determination, the second controller 270 controls the decoder 260 to decode the bitstream deformatted by the deformatter 265 to meet the expanded number of channels. In this case, the second controller 270 controls the decoder 260 to decode the bitstream by using the extracted additional information.

Whether an expanded channel exists may be determined by checking whether the multi-channel restoration information is included in the additional information.

For example, if the bitstream received to the decoding apparatus 250 includes 5.1 channels according to the AC-3 standard, the additional information may include the multi-channel restoration information for expanding the bitstream of 5.1 channels to an audio signal of 10.2 channels. In this case, the second controller 270 controls the decoder 260 to extract the additional information including the multi-channel restoration information and output the audio signal of 10.2 channels from the bitstream of 5.1 channels by using the multi-channel restoration information.

If the 3D information is included in the extracted additional information, the second controller 270 may control the decoder 260 to reproduce the audio signal in a 3D way by using the 3D information. In detail, the decoder 260 decodes the bitstream to output an audio signal having a predetermined depth under a control of the second controller 270.

If both the multi-channel restoration information and the 3D information are included in the extracted additional information, the second controller 270 may control the decoder 260 to decode the bitstream so as to have more than the number of channels according to the predetermined standard and output audio signals, each audio signal having a predetermined depth.

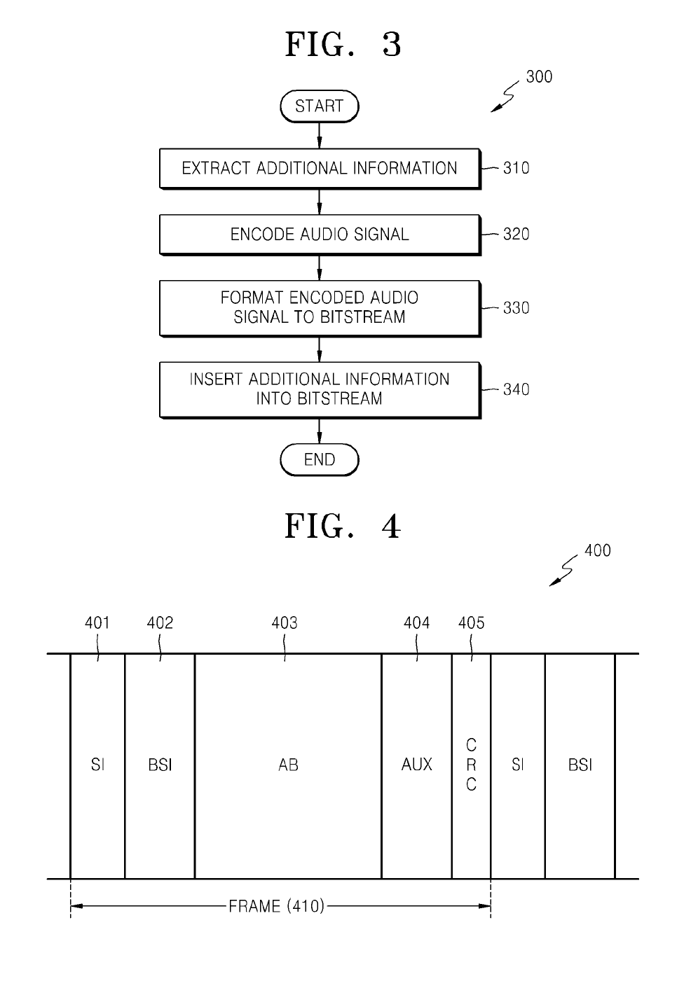

Operations of the encoding apparatus 210 and the decoding apparatus according to an exemplary embodiment are the same as operations of the signal processing methods according to exemplary embodiments to be described with reference to FIGS. 3 to 12.

FIG. 3 is a flowchart illustrating a signal processing method 300 according to an exemplary embodiment.

Referring to FIG. 3, according to the signal processing method 300, in operation 310, additional information that is information for performing at least one of channel number expansion and 3D reproduction of an audio signal is extracted or generated. Operation 310 may be performed by the first controller 230 of the encoding apparatus 210. The additional information may be input to the encoding apparatus 210 from the outside, wherein the first controller 230 extracts the input additional information. Alternatively, the additional information may be generated by the first controller 230 according to a request of a user or a determination of the encoding apparatus 210.

In operation 320, an audio signal input to the encoding apparatus 210 is encoded according to a predetermined standard. Here, if the number of channels included in the input audio signal is greater than the number of channels allowed in the predetermined standard, the input audio signal is down-mixed.

For example, if the encoding apparatus 210 conforms to the AC-3 standard, the input audio signal is encoded to meet 5.1 channels. In detail, when the input audio signal exceeds 5.1 channels, e.g., if the input audio signal is a 10.2-channel audio signal, the input audio signal is down-mixed to 5.1 channels. In this case, the additional information may include restoration information for expanding the 5.1 channels to the 10.2-channels. Operation 320 may be performed by the encoder 220 under a control of the first controller 230.

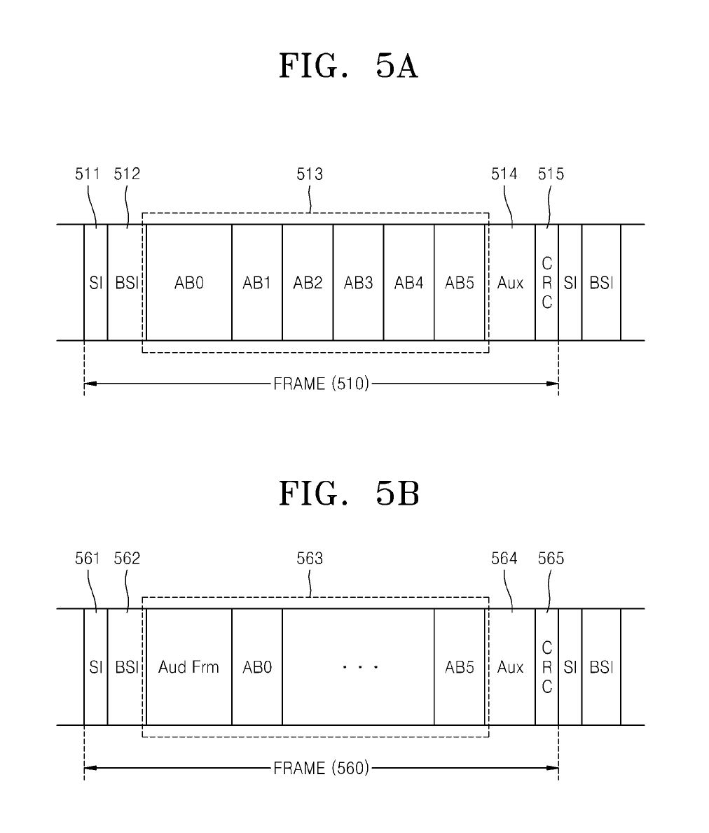

In operation 330, the encoded audio signal output from the encoder 220 is formatted to a bitstream including BSI, at least one AB, and an auxiliary data field. Operation 330 may be performed by the formatter 255 under a control of the first controller 230. The bitstream generated in operation 330 is described in detail with reference to FIGS. 4 and 5 below.

FIG. 4 is a configuration diagram of a bitstream according to an exemplary embodiment. An information storage medium according to an exemplary embodiment records and stores the bitstreams illustrated in FIGS. 4 and 5.

Referring to FIG. 4, a bitstream 400 generated in operation 330 includes a plurality of consecutive frames 410. A single frame 410 includes BSI 402, an AB field 403, and an auxiliary data field 404. The AB field 403 includes at least one AB. The frame 410 further includes synchronization information (SI) 401. The frame 410 may further include a cyclic redundancy check (CRC) code 405 or an error detection code (not shown).

The SI indicates the start of a frame and has a fixed number of bits. The BSI 402 includes information required to reproduce an actual audio signal or information required to decode an audio signal. The AB field 403 is a field on which an actual audio signal is carried.

The auxiliary data field 404 may include data remaining by excluding the actual audio signal in the single frame 410. The auxiliary data field 404 may also exist to perform a buffer control.

FIG. 5 is a configuration diagram of a bitstream according to the AC-3 standard and a configuration diagram of a bitstream according to the Enhanced AC-3 standard.

FIG. 5A is a configuration diagram of a bitstream according to the AC-3 standard. Since a frame 510, SI 511, BSI 512, an AB field 513, and auxiliary data field 514, and a CRC code 515 in FIG. 5A respectively correspond to the frame 410, the SI 401, the BSI 402, the AB field 403, the auxiliary data field 404, and the CRC code 405 in FIG. 4, the description made in FIG. 4 is not repeated again.

In FIG. 5A, according to the AC-3 standard, the AB field 513 includes 6 audio blocks AB0, AB1, AB2, AB3, AB4, and AB5, each AB having a variable length and including an actual audio signal.

In detail, an actual audio signal having maximum 5.1 channels according to the AC-3 standard is carried on the audio blocks AB0, AB1, AB2, AB3, AB4, and AB5 and transmitted to the decoding apparatus 250.

FIG. 5B is a configuration diagram of a bitstream according to the Enhanced AC-3 standard. Since a frame 560, SI 561, BSI 562, an AB field 563, and auxiliary data field 564, and a CRC code 565 in FIG. 5B respectively correspond to the frame 410, the SI 401, the BSI 402, the AB field 403, the auxiliary data field 404, and the CRC code 405 in FIG. 4, the description made in FIG. 4 is not repeated again.

In FIG. 5B, according to the Enhanced AC-3 standard, the AB field 563 includes an audio frame (AudFrm) and n audio blocks. According to the Enhanced AC-3 standard, n may be 1, 2, 3, or 6. FIG. 5B illustrates a case where n=6. Each of 6 audio blocks AB0, AB1, AB2, AB3, AB4, and AB5 has a variable length and includes an actual audio signal.

In detail, an actual audio signal having maximum 13.1 channels according to the Enhanced AC-3 standard is carried on the audio blocks AB0, AB1, AB2, AB3, AB4, and AB5 and transmitted to the decoding apparatus 250.

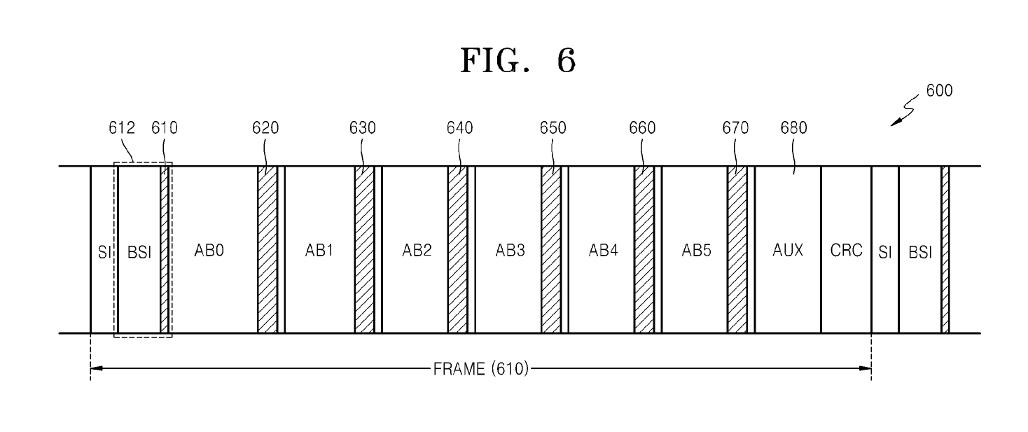

FIG. 6 is a configuration diagram of a bitstream 600 into which additional information is inserted, according to an exemplary embodiment. The bitstream 600 illustrated in FIG. 6 is a bitstream according to the AC-3 standard. Thus, the bitstream 600 illustrated in FIG. 6 corresponds to the bitstream 600 illustrated in FIG. 5A. Operation 340 is described with reference to FIG. 6.

In operation 340, the additional information extracted in operation 310 is inserted into at least one of additional BSI (addbsi) 610 included in BSI 612, skip fields 620, 630, 640, 650, 660, and/or 670 included in audio blocks AB0, AB1, AB2, AB3, AB4, and/or AB5, and auxiliary data bits (auxbits) 680 included in an auxiliary data field. When the additional information is inserted into the at least one audio blocks AB0, AB1, AB2, AB3, AB4, and/or AB5, the additional information may be inserted into at least one of the skip fields 620, 630, 640, 650, 660, and 670 respectively corresponding to the audio blocks AB0, AB1, AB2, AB3, AB4, and AB5.

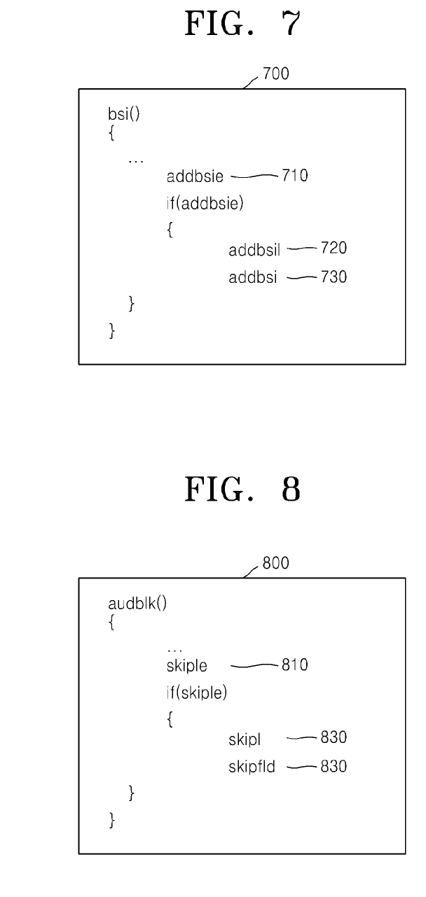

Structures of BSI including additional information, an audio block including additional information, and an auxiliary data field including additional information are described in detail with reference to FIGS. 7 to 9.

FIG. 7 illustrates BSI 700 including additional information.

Referring to FIG. 7, the BSI 700 (referred to as ‘bsi’ in FIG. 7) includes additional bitstream information existence (addbsie) information 710 indicating the presence or absence of additional bitstream information (addbsi), additional bitstream information length (addbsil) information 720, and additional bitstream information (addbsi) 730.

In detail, the addbsie information 710 indicates whether additional bitstream information (addbsi) exists. The addbsil information 720 includes information regarding a data length of the additional bitstream information (addbsi). The additional bitstream information (addbsi) 730 includes the additional information.

FIG. 8 illustrates an audio block 800 including additional information.

Referring to FIG. 8, the audio block 800 (referred to as ‘audblk’ in FIG. 8) includes skip length existence (skiple) information 810 indicating the presence or absence of a skip field (skipfld), skip length (skipl) information 820 indicating a length of the skip field (skipfld), and a skip field (skipfld) 830 including the additional information.

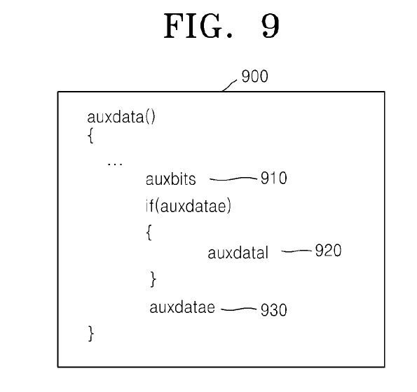

FIG. 9 illustrates an auxiliary data field 900 including additional information.

Referring to FIG. 9, the auxiliary data field 900 (referred to as ‘auxdata’ in FIG. 9) includes auxiliary data bits (auxbits) 910 including the additional information, auxiliary data length (auxdatal) information 920, and auxiliary data existence (auxdatae) information 930 indicating the presence/absence of auxiliary data.

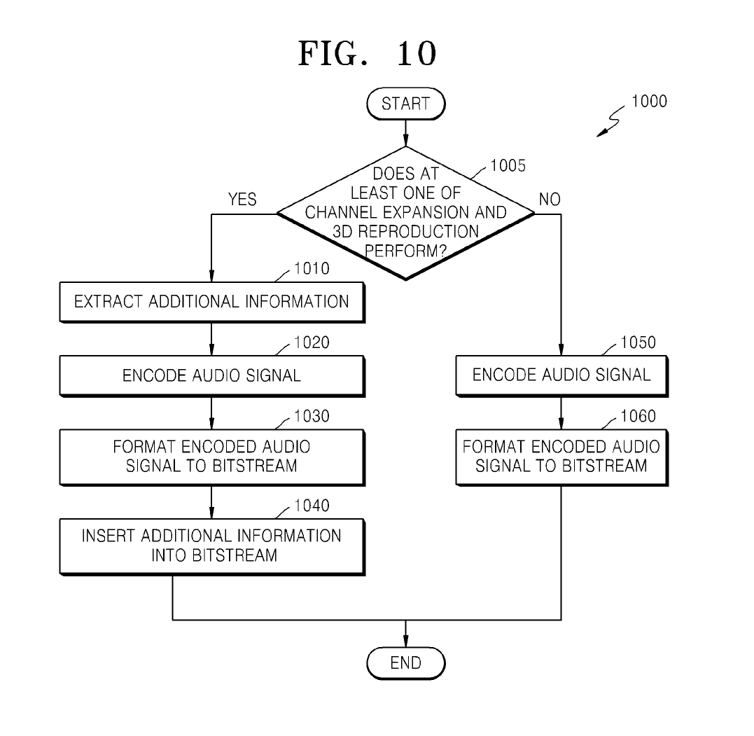

FIG. 10 is a flowchart illustrating a signal processing method 1000 according to another exemplary embodiment. Since operations 1010, 1020, 1030, and 1040 in FIG. 10 are identical to operations 310, 320, 330, and 340 in FIG. 3, the description made in FIG. 3 is not repeated again. Comparing with the signal processing method 300, the signal processing method 1000 may further include at least one of operations 1005, 1050, and 1060.

In detail, in operation 1005, it is determined whether at least one of channel number expansion and 3D reproduction of an audio signal is performed. The determination in operation 1005 may be performed by the first controller 230 according to a request of a user or a determination of the encoding apparatus 210.

The channel number expansion indicates that an audio signal having more than the number of channels allowed in a predetermined standard is generated when the decoding apparatus 250 decodes and outputs the audio signal. For example, the channel number expansion indicates allowing the decoding apparatus 250 conforming to the AC-3 standard to output an audio signal having 10.2 channels even though the AC-3 standard allows up to maximum 5.1 channels. The 3D reproduction of an audio signal indicates that audio signals have depth information, wherein each audio signal is reproduced with a different stereoscopic sense according its own depth information.

If it is determined in operation 1005 that at least one of the channel number expansion and the 3D reproduction of an audio signal is performed, the signal processing method 1000 proceeds to operation 1010.

If it is determined in operation 1005 that any one of the channel number expansion and the 3D reproduction of an audio signal is not performed, the audio signal is encoded according to the predetermined standard in operation 1050 without performing operation 1010 to extract additional information for the channel number expansion and the 3D reproduction of the audio signal.

In operation 1060, the encoded audio signal is formatted to a bitstream defined by the predetermined standard.

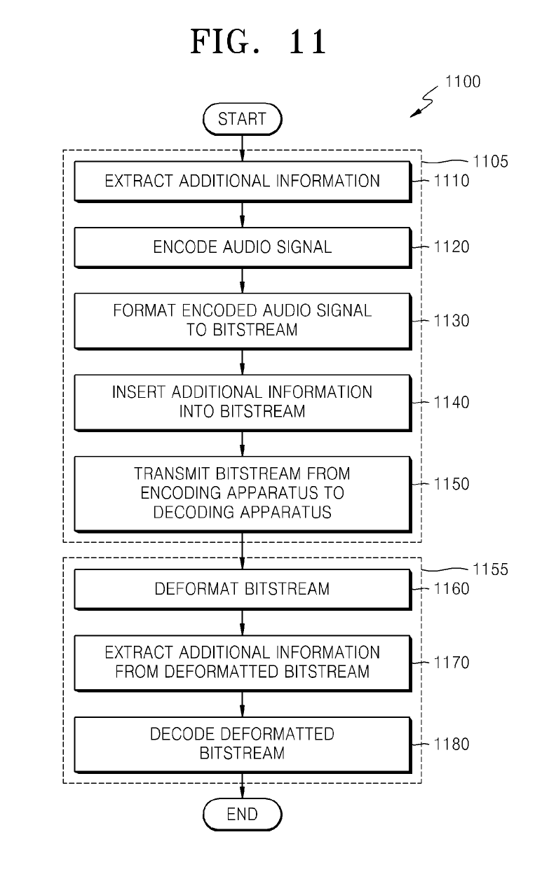

FIG. 11 is a flowchart illustrating a signal processing method 1100 according to another exemplary embodiment. Since operations 1110, 1120, 1130, and 1140 of the signal processing method 1100 are identical to operations 310, 320, 330, and 340 in FIG. 3, the description made in FIG. 3 is not repeated again. Comparing with the signal processing method 300, the signal processing method 1100 of FIG. 11 may further include at least one of operations 1150, 1160, 1170, and 1180.

After operation 1140, a bitstream into which additional information is inserted is transmitted from the encoding apparatus 210 to the decoding apparatus 250 in operation 1150.

In the signal processing method 1100, an operation block 1105 is performed by the encoding apparatus 210, and a subsequent operation block 1155 is performed by the decoding apparatus 250.

In operation 1160, the decoding apparatus 250 receives the bitstream transmitted in operation 1150 and deformats the received bitstream. Operation 1160 may be performed by the deformatter 265. In detail, operation 1160 restores the audio signal formatted according to the predetermined standard to the format before performing operation 1130.

In operation 1170, the decoding apparatus 250 extracts the additional information from at least one of additional BSI (addbsi), a skip field (skipfld, and auxiliary data bits (auxbits) included in the deformatted bitstream. In detail, operation 1170 may be performed by the decoding apparatus 250 under a control of the second controller 270. In more detail, operation 1170 may be performed by a parser (not shown) included in the decoding apparatus 250 under a control of the second controller 270.

In operation 1180, the decoding apparatus 250 decodes the bitstream deformatted in operation 1160 according to the predetermined standard. In detail, if the extracted additional information includes multi-channel restoration information, the decoding apparatus 250 decodes the bitstream so that the number of channels included in the bitstream, i.e., the number of channels equal to or less than that allowed in the predetermined standard, is expanded using the multi-channel restoration information. For example, if the extracted additional information includes restoration information for expanding 5.1 channels to 10.2 channels, the decoder 260 receives the bitstream having 5.1 channels and outputs an audio signal of 10.2 channels.

If the extracted additional information includes 3D information, the bitstream may be decoded by adding depths according to the 3D information thereto. The decoded audio signals may have predetermined depths and accordingly may be reproduced with different stereoscopic senses.

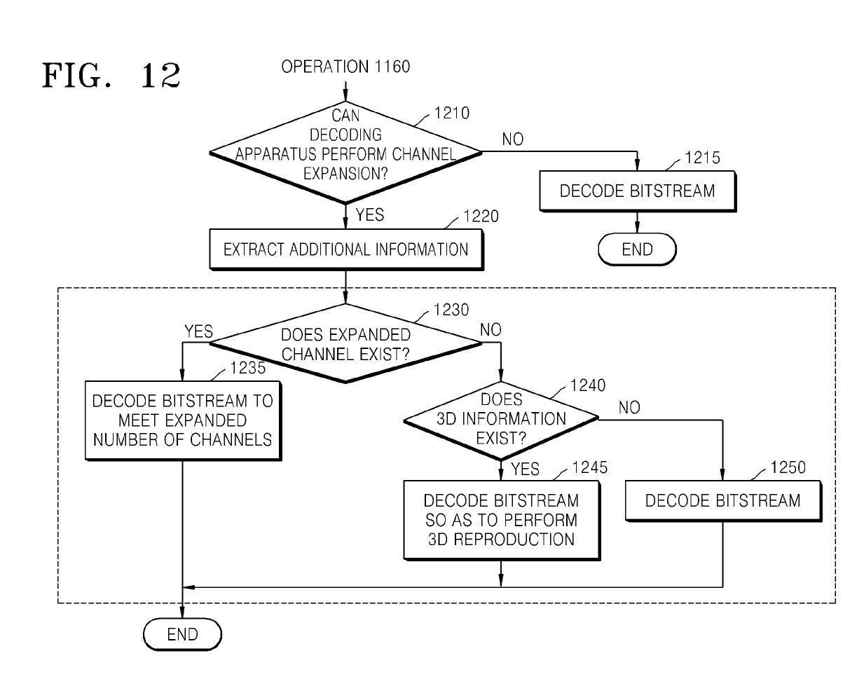

FIG. 12 is a flowchart illustrating a signal processing method according to another exemplary embodiment. Since operations 1220 and 1215 of FIG. 12 respectively correspond to operations 1170 and 1180 of FIG. 11, the description made in FIG. 11 is not repeated again.

Referring to FIG. 12, after operation 1160, it is determined in operation 1210 whether the decoding apparatus 250, which has received the bitstream, can perform the channel number expansion.

If the decoding apparatus 250, which has received the bitstream, cannot perform the channel number expansion as a result of the determination of operation 1210, the decoding apparatus 250 decodes the deformatted bitstream without extracting the additional information in operation 1215.

If the decoding apparatus 250, which has received the bitstream, can perform the channel number expansion as a result of the determination of operation 1210, the decoding apparatus 250 extracts the additional information from the received bitstream in operation 1220.

In operation 1230, the decoding apparatus 250 determines whether an expanded channel exists. Operation 1230 may be performed by decoding the additional information extracted in operation 1220 and determining whether multi-channel restoration information is included the decoded additional information.

If an expanded channel exists as a result of the determination of operation 1230, the decoding apparatus 250 decodes the deformatted bitstream to meet the expanded number of channels by using the additional information in operation 1235. If an expanded channel exists and the additional information includes 3D information, a depth is added to the audio signal decoded to meet the expanded number of channels. If no expanded channel exists as a result of the determination of operation 1230, the decoding apparatus 250 determines in operation 1240 whether the additional information includes 3D information.

If the additional information does not include 3D information as a result of the determination of operation 1240, the decoding apparatus 250 decodes the deformatted bitstream without performing channel expansion or adding a depth in operation 1250.

If the additional information includes 3D information as a result of the determination of operation 1240, the decoding apparatus 250 decodes the deformatted bitstream so that 3D reproduction of the audio signal can be performed and adds a depth to the decoded audio signal in operation 1245.

The method invention can also be embodied as computer-readable codes or programs on a computer-readable recording medium. The computer-readable recording medium is any data storage device that can store programs or data which can be thereafter read by a computer system. Examples of the computer-readable recording medium include read-only memory (ROM), random-access memory (RAM), CD-ROMs, magnetic tapes, hard disks, floppy disks, flash memory, optical data storage devices, and so on. The computer-readable recording medium can also be distributed over network coupled computer systems so that the computer-readable code is stored and executed in a distributed fashion.

While the present invention has been particularly shown and described with reference to exemplary embodiments thereof, it will be understood by those of ordinary skill in the art that various changes in form and details may be made therein without departing from the spirit and scope as defined by the following claims.

What is claimed is:

1. A signal processing method comprising:
extracting additional information which is utilized for performing at least one of a channel number expansion of an audio signal in an encoding apparatus and a three-dimensional (3D) reproduction of the audio signal in the encoding apparatus;
encoding the audio signal according to a predetermined standard;
formatting the encoded audio signal into a bitstream including bitstream information, at least one audio block and an auxiliary data field; and
inserting the additional information into at least one of additional bitstream information included in the bitstream information, a skip field included in the audio block and auxiliary data bits included in the auxiliary data field.

2. The signal processing method of claim 1, wherein the additional information comprises at least one of multi-channel restoration information for expanding a number of channels to be greater than a number of audio channels included in the bitstream, and 3D information of the audio signal.

3. The signal processing method of claim 2, wherein the multi-channel restoration information comprises at least one of information regarding the audio channels, information for down-mixing the audio signal according to a number of channels defined in the predetermined standard and parameter information for up-mixing the down-mixed audio signal.

4. The signal processing method of claim 1, wherein the bitstream information comprises:
additional bitstream existence information indicating whether the additional bitstream information exists; and
length information of the additional bitstream information, and wherein the additional bitstream information includes the additional information.

5. The signal processing method of claim 1, wherein the audio block comprises:
skip field existence information indicating whether the skip field exists; and
length information of the skip field,
wherein the skip field includes the additional information.

6. The signal processing method of claim 1, wherein the auxiliary data field comprises:
the auxiliary data bits including the additional information;
length information of the auxiliary data; and
auxiliary data existence information which indicates whether the auxiliary data exists.

7. The signal processing method of claim 1, further comprising determining whether to perform at least one of the channel number expansion and the 3D reproduction of the audio signal.

8. The signal processing method of claim 1, wherein the encoding comprises, if a number of channels included in the audio signal input to the encoding apparatus is greater than a number of channels allowed in the predetermined standard, down-mixing the audio signal according to a number of channels allowed in the predetermined standard.

9. The signal processing method of claim 2, further comprising if the additional information is inserted into the bitstream, transmitting the bitstream from the encoding apparatus to the decoding apparatus.

10. The signal processing method of claim 9, further comprising:
deformatting the bitstream in the decoding apparatus; and
extracting the additional information from at least one of the additional bitstream information, the skip field and the auxiliary data bits of the deformatted bitstream.

11. The signal processing method of claim 10, further comprising:
determining whether an expanded channel exists, based on the extracted additional information; and
if an expanded channel exists, decoding the deformatted bitstream according to the expanded number of channels, based on the extracted additional information.

12. The signal processing method of claim 9, further comprising determining whether the decoding apparatus can perform the channel number expansion.

13. The signal processing method of claim 12, further comprising, if the decoding apparatus cannot perform the channel number expansion, decoding the deformatted bitstream without extracting the additional information.

14. An encoding apparatus comprising:
a controller which extracts additional information that is information for performing at least one of a channel number expansion of an audio signal and a three-dimensional (3D) reproduction of the audio signal;
an encoder which encodes the audio signal according to a predetermined standard under a control of the controller; and
a formatter which formats the encoded audio signal into a bitstream including bitstream information, at least one audio block and an auxiliary data field,
wherein the controller which controls to insert the additional information into at least one of additional bitstream information included in the bitstream information, a skip field included in the audio block and auxiliary data bits included in the auxiliary data field.

15. The encoding apparatus of claim 14, wherein the additional information comprises at least one of multi-channel restoration information, which is for expanding the number of channels to be greater than a number of audio channels included in the bitstream, and 3D information of the audio signal.

16. The encoding apparatus of claim 15, wherein if the additional information is inserted into the bitstream, the controller transmits the bitstream from the encoding apparatus to a decoding apparatus.

17. A decoding apparatus comprising:
a deformatter which deformats a bitstream including bitstream information, at least one audio block and an auxiliary data field;
a controller which extracts additional information, which is utilized for performing at least one of a channel number expansion and a three-dimensional (3D) reproduction of the bitstream from at least one of additional bitstream information included in the bitstream information, a skip field included in the audio block and auxiliary data bits included in the auxiliary data field; and
a decoder which decodes the deformatted bitstream.

18. The decoding apparatus of claim 17, wherein the controller determines based on the extracted additional information whether an expanded channel exists, and
if an expanded channel exists, the decoder decodes the deformatted bitstream according to meet the expanded number of channels.

19. The decoding apparatus of claim 17, wherein the additional information comprises at least one of multi-channel restoration information, which is for expanding the number of channels to a number greater than a number of audio channels included in the bitstream, and 3D information of the audio signal.

20. A non-transitory information storage medium storing a bitstream comprising an audio signal, the bitstream comprising:
bitstream information including an additional bitstream information area;
at least one audio block including a skip field area; and
an auxiliary data field including an auxiliary data bit area,
wherein at least one of the additional bitstream information area, the skip field area and the auxiliary data bit area includes additional information which is utilized for performing at least one of a channel number expansion and a three-dimensional (3D) reproduction of the audio signal.

21. The information storage medium of claim 20, wherein the additional information comprises at least one of multi-channel restoration information, which is for expanding the number of channels to a number greater than a number of audio channels included in the bitstream, and 3D information of the audio signal.

22. The information storage medium of claim 21, wherein the multi-channel restoration information comprises at least one of information regarding the audio channels, information for down-mixing the audio signal according to a number of channels defined in the predetermined standard, and parameter information for up-mixing the down-mixed audio signal.

23. The information storage medium of claim 20, wherein the bitstream information comprises:
additional bitstream existence information which indicates whether the additional bitstream information exists; and
length information of the additional bitstream information, and
wherein the additional bitstream information includes the additional information.

24. The information storage medium of claim 20, wherein the audio block comprises:
skip field existence information which indicates whether the skip field exists; and
length information of the skip field,
wherein the skip field includes the additional information.

25. The information storage medium of claim 20, wherein the auxiliary data field comprises:
the auxiliary data bits which include the additional information;
length information of the auxiliary data; and
auxiliary data existence information which indicates whether the auxiliary data exists.
